(19) United States
(12) Patent Application Publication
(10) Pub. No.: US 2001/0011973 A1
(43) Pub. Date: Aug. 9, 2001

(54) Method and apparatus for driving plasma display panel

(76) Inventors: Kyoung-ho Kang, Asan-city (KR); Jeong-duk Ryeom, Cheonan-city (KR); Seong-charn Lee, Seoul (KR)

Correspondence Address: STAAS & HALSEY LLP, 700 11TH STREET, NW, SUITE 500, WASHINGTON, DC, 20001, US

(21) Appl. No.: 09/727,449

(22) Filed: Dec. 4, 2000

(30) Foreign Application Priority Data
Dec. 17, 1999 (KR) 99-58761

(51) Int. Cl. G09G 3/28

(52) U.S. Cl. 345/60

(57) ABSTRACT

A method of driving a plasma display panel having front and rear substrates opposed to and facing each other, X and Y electrode lines formed between the front and rear substrates to be parallel to each other, address electrode lines formed to be orthogonal to the X and Y electrode lines, to define corresponding display cells (pixels) at interconnections. If the average brightness of an image displayed on the plasma display panel is maintained at a predetermined level or below for a predetermined time, a display discharge is performed at all the display cells at least one time.

### CROSS-REFERENCE TO RELATED APPLICATIONS

This application claims the benefit of Korean Application No. 99-58761, filed Dec. 17, 1999, in the Korean Patent Office, the disclosure of which is incorporated herein by reference.

### BACKGROUND OF THE INVENTION

1. Field of the Invention

The present invention relates to a method and apparatus for driving a plasma display panel, and more particularly, to a method and apparatus for driving a three-electrode surface-discharge plasma display panel.

2. Description of the Related Art

FIG. 1 shows a structure of a general three-electrode surface-discharge plasma display panel, FIG. 2 shows an electrode line pattern of the plasma display panel shown in FIG. 1, and FIG. 3 shows an example of a pixel of the plasma display panel shown in FIG. 1. Referring to the drawings, address electrode lines A₁, A₂, . . . Aₘ, dielectric layers 11 and 15, Y electrode lines Y₁,.Y₂, . . . Yₙ, X electrode lines X₁, X₂, . . . Xₙ, phosphors 16, partition walls 17 and an MgO protective film 12 are provided between front and rear glass substrates 10 and 13 of a general surface-discharge plasma display panel 1.

The address electrode lines A₁, A₂, . . . Aₘ are provided over the front surface of the rear glass substrate 13 in a predetermined pattern. The lower dielectric layer 15 covers the entire front surface of the address electrode lines A₁, A₂, . . . Aₘ. The partition walls 17 are formed on the front surface of the lower dielectric layer 15 to be parallel to the address electrode lines A₁, A₂, . . . Aₘ. The partition walls 17 define discharge areas of the respective pixels and prevent optical crosstalk among pixels. The phosphors 16 are coated between partition walls 17.

The X electrode lines X₁, X₂, . . . Xₙ and the Y electrode lines Y₁,.Y₂, . . . Yₙ are arranged on the rear surface of the front glass substrate 10 so as to be orthogonal to the address electrode lines A₁, A₂, . . . Aₘ, in a predetermined pattern. The respective intersections define corresponding pixels. Each of the X electrode lines X₁, X₂, . . . Xₙ and the Y electrode lines Y₁, .Y₂, . . . Yₙ comprises a transparent, conductive indium tin oxide (ITO) electrode line (Xₙₐ or Yₙₐ of FIG. 3) and a metal bus electrode line (X_{nb} or Y_{nb} of FIG. 3). The upper dielectric layer 11 is entirely coated over the rear surface of the X electrode lines X₁, X₂, . . . Xₙ and the Y electrode lines Y₁,.Y₂, . . . Yₙ. The MgO protective film 12 for protecting the panel 1 against strong electrical fields is entirely coated over the rear surface of the upper dielectric layer 11. A gas for forming plasma is hermetically sealed in a discharge space 14.

The above-described plasma display panel is basically driven such that a reset step, an address step and a sustain-discharge step are sequentially performed in a unit subfield. In the reset step, wall charges remaining from the previous subfield are erased and space charges are evenly formed. In the address step, the wall charges are formed in a selected pixel area. Also, in the sustain-discharge step, light is produced at the pixel at which the wall charges are formed in the address step. In other words, if alternating pulses of a relatively high voltage are applied between the X electrode lines X₁, X₂, . . . Xₙ and the Y electrode lines Y₁,.Y₂, . . . Yₙ, a surface discharge occurs at the pixels at which the wall charges are formed. Here, plasma is formed at the gas layer of the discharge space 14 and phosphors 16 are excited by ultraviolet rays to thus emit light.

FIG. 4 shows the structure of a unit display period based on a driving method of a general plasma display panel. Here, a unit display period represents a frame in the case of a progressive scanning method, and a field in the case of an interlaced scanning method. The driving method shown in FIG. 4 is generally referred to as a multiple address overlapping display driving method. According to this driving method, pulses for a display discharge are consistently applied to all X electrode lines (X₁, X₂, . . . Xₙ of FIG. 1) and all Y electrode lines (Y₁,.Y₂, . . . Y₄₈₀) and pulses for resetting or addressing are applied between the respective pulses for a display discharge. In other words, the reset and address steps are sequentially performed with respect to individual Y electrode lines or groups, within a unit subfield, and then the display discharge step is performed for the remaining time period. Thus, compared to an address-display separation driving method, the multiple address overlapping display driving method has an enhanced displayed luminance. Here, the address-display separation driving method refers to a method in which within a unit subfield, reset and address steps are performed for all Y electrode lines Y₁, Y₂, . . . Y₄₈₀, during a certain period and a display discharge step is then performed.

Referring to FIG. 4, a unit frame is divided into 8 subfields SF₁, SF₂, . . . SF₈ for achieving a time-divisional gray scale display. In each subfield, reset, address and display discharge steps are performed, and the time allocated to each subfield is determined by a display discharge time. For example, in the case of displaying 256 scales by 8-bit video data in the unit of frames, if a unit frame (generally 1/60 seconds) comprises 256 unit times, the first subfield SF₁, driven by the least significant bit (LSB) video data, has 1 (2⁰) unit time, the second subfield SF₂ 2 (2¹) unit times, the third subfield SF₃ 4 (2²) unit times, the fourth subfield SF₄ 8 (2³) unit times, the fifth subfield SF₅ 16 (2⁴) unit times, the sixth subfield SF₆ 32 (2⁵) unit times, the seventh subfield SF₇ 64 (2⁶) unit times, and the eighth subfield SF₈, driven by the most significant bit (MSB) video data, 128 (2⁶) unit times. In other words, since the sum of unit times allocated to the respective subfields is 257 unit times, 255 scales can be displayed, 256 scales including one scale which is not display-discharged at any subfield.

In the driving method of the multiple address overlapping display, a plurality of subfields SF₁, SF₂, . . . SF₈ are alternately allocated in a unit frame. Thus, the time for a unit subfield equals the time for a unit frame. Also, the elapsed time of all unit subfields SF₁, SF₂, . . . SF₈ is equal to the time for a unit frame. The respective subfields overlap on the basis of the driven Y electrode lines Y₁, Y₂, . . . Y₄₈₀, to form a unit frame. Thus, since all subfields SF₁, SF₂, . . . SF₈ exist in every timing, time slots for addressing depending on the number of subfields are set between pulses for display discharging, for the purpose of performing the respective address steps.

FIGS. 5A through 5K show driving signals in a unit display period based on a conventional driving method. Referring to FIGS. 5A through 5K, the minimum driving periods T₁₁+T₁₂, T₂₁+T₂₂, T₃₁+T₃₂, T₄₁+T₄₂, T₅₁+T₅₂, . . . each includes a display discharge period, a reset period and an address period T₁₂, T₂₂, T₃₂, T₄₂, T₅₂, . . . , Here, reference marks T₁₁, T₂₁, T₃₁, T₄₁, T₅₁, . . . denote pulses including the display discharge periods and the reset periods, respectively. During the minimum display discharge period, pulses 2 and 5 for display discharges are alternately applied once to each of Y and X electrode lines, and the minimum reset and address periods T₁₂, T₂₂, T₃₂, T₄₂, T₅₂, . . . occur between the minimum display discharge. In other words, during the quiescent period of a sustain discharge, the minimum reset and address periods occur.

During the minimum address period, the scan pulses 6 are applied to Y electrode lines corresponding to four subfields, and simultaneously the corresponding display data signals SA_{1..m} are applied to the respective address electrode lines. In FIGS. 5A through 5K, reference marks S_{Y1}, S_{Y2}, . . . S_{Y8} denote Y electrode driving signals applied to Y electrode lines corresponding to first through eighth subfields SF₁, SF₂, . . . SF₈. In more detail, S_{Y1} denotes a driving signal applied to a selected Y electrode line of the first subfield SF₁, S_{Y2} denotes a driving signal applied to a selected Y electrode line of the second subfield SF₂, S_{Y3} denotes a driving signal applied to a selected Y electrode line of the third subfield SF₃, S_{Y4} denotes a driving signal applied to a selected Y electrode line of the fourth subfield SF₄, S_{Y5} denotes a driving signal applied to a selected Y electrode line of the fifth subfield SF₅, S_{Y6} denotes a driving signal applied to a selected Y electrode line of the sixth subfield SF₆, S_{Y7} denotes a driving signal applied to a selected Y electrode line of the seventh subfield SF₇ and S_{Y8} denotes a driving signal applied to a selected Y electrode line of the eighth subfield SF₈, respectively (FIGS. 5A through 5H). Reference marks S_{X1..4} (FIG. 5I) and S_{X5..8} (FIG. 5J) denote driving signals applied to X electrode line groups corresponding to scanned Y electrode lines, S_{A1..m} (FIG. 5K) denotes display data signals corresponding to scanned Y electrode lines, and GND denotes a ground voltage.

During the respective display discharge periods, display discharges occur at pixels where wall charges have been formed, by alternately applying pulses 2 and 5 for display discharges to the X and Y electrode lines (X₁, X₂, . . . Xₙ and Y₁, Y₂, . . . Y₄₈₀ of FIG. 1). During the respective minimum reset periods, reset pulses 3 are applied to the Y electrode lines to be scanned during subsequent address periods for forming space charges while erasing the wall charges remaining from the previous subfield. During the minimum address periods T₁₂, T₂₂, T₃₂, T₄₂, T₅₂, . . . , while scan pulses 6 are sequentially applied to the Y electrode lines corresponding to four subfields, the corresponding display data signals S_{A1..m} are applied to the respective address electrode lines A₁, A₂, . . . Aₘ, thereby forming wall charges at pixels to be displayed.

Predetermined quiescent periods exist after application of the reset pulses 3 and before application of the scan pulses 6, to make space charges be distributed smoothly at the corresponding pixel areas. In FIGS. 5A through 5K, T₁₂, T₂₁, T₂₂ and T₃₁ are quiescent periods for the Y electrode lines of the first through fourth subfields SF₁ through SF₄, and T₂₂, T₃₁, T₃₂ and T₄₁ are quiescent periods for the Y electrode lines of the fifth through eighth subfields SF₅ through SF₈. Although the pulses 5 for display discharges applied during the respective quiescent periods cannot actually cause a display discharge, they allow space charges to be distributed smoothly at the corresponding pixel areas. However, the pulses 2 for display discharges applied during non-quiescent periods cause display discharges to occur at the pixels where the wall charges have been formed by the scan pulses 6 and the display data signals S_{A1 . . . m}.

During the minimum address period T₃₂ or T₄₁ between the final pulses among the pulses 5 for display discharge applied during the quiescent periods and the first subsequent pulses 2, addressing is performed four times. For example, during the period T₃₂, addressing is performed for the corresponding Y electrode lines of the first through fourth subfields SF₁ through SF₄. Also, during the period T₄₂, addressing is performed for the corresponding Y electrode lines of the fifth through eighth subfields SF₅ through SF₈. As described above with reference to FIG. 4, since all subfields SF₁, SF₂, . . . SF₈ exist at every timing, time slots for addressing, depending on the number of subfields are set during the minimum address periods for the purpose of performing the respective address steps.

After the pulses 2 and 5 for display discharges simultaneously applied to the Y electrode lines Y₁, Y₂, . . . Yₙ terminate, the pulses 2 and 5 for display discharges simultaneously applied to the electrode lines X₁, X₂, . . . Xₙ start to occur. Scan pulses 6 and the corresponding display data signals S_{A1..m} are applied during the minimum address period before the pulses 2 and 5 for display discharges simultaneously applied to the Y electrode lines Y₁, Y₂, . . . Yₙ of the next minimum display discharge period start to occur after the pulses 2 and 5 for display discharges simultaneously applied to the electrode lines X₁, X₂, . . . Xₙ terminate.

According to the above-described conventional driving method, even if an image having a low brightness due to poor brightness of ambient background, is displayed on a plasma display panel (1 of FIG. 1) for a long time, driving is performed just in the usual manner. However, if the low-brightness image is displayed for a long time, space charges gradually vanish from display cells (pixels) at which display discharges do not occur for a long time. Due to such deficient space charges, although addressing discharges are performed for emission of light, sufficient space charges are not produced. Consequently, the discharging stability is gradually reduced in proportion to the time in which the low-brightness image is displayed on the plasma display panel (1 of FIG. 1).

### SUMMARY OF THE INVENTION

To solve the above problem, it is an object of the present invention to provide a method and apparatus for driving a plasma display panel which can prevent the discharging stability from decreasing even with a prolonged time for displaying a low-brightness image on the plasma display panel.

Additional objects and advantages of the invention will be set forth in part in the description which follows and, in part, will be obvious from the description, or may be learned by practice of the invention.

To achieve the above and other objects of the present invention, there is provided a method of driving a plasma display panel having front and rear substrates opposed to and facing each other, X and Y electrode lines formed between the front and rear substrates to be parallel to each other, address electrode lines formed to be orthogonal to the X and Y electrode lines, to define corresponding pixels at interconnections, wherein if the average brightness of an image displayed on the plasma display panel is maintained at a predetermined level or below for a predetermined time, a display discharge is performed at all the display cells at least one time.

Accordingly, if the low-brightness image is displayed for a long time, all display cells perform the minimum display discharges within the predetermined time, thereby preventing space charges from vanishing from the display cells at which display discharges do not occur. Since the space charges are not deficient, sufficient wall charges are produced by performing addressing discharges for radiation of light after a long time. As a result, the discharging stability can be prevented from decreasing even with a prolonged time of displaying the low-brightness image on the plasma display panel.

According to another aspect of the present invention, there is provided an apparatus for driving a plasma display panel having front and rear substrates opposed to and facing each other, X and Y electrode lines formed between the front and rear substrates to be parallel to each other, address electrode lines formed to be orthogonal to the X and Y electrode lines, to define corresponding pixels at interconnections, the apparatus including a brightness detector which monitors whether or not the average brightness of an image displayed on the plasma display panel is maintained at a predetermined level or below and generates a corresponding brightness control signal, a controller which generates driving control signals according to an externally applied image signal and the brightness control signal output from the brightness detector, an address driver which processes an address signal among the driving control signals supplied from the controller to generate display data signals and applies the generated display data signals to the address electrode lines, an X driver which processes an X driving control signal among the driving control signals supplied from the controller and applies the same to the X electrode lines, and a Y driver which processes a Y driving control signal among the driving control signals supplied from the controller and applies the same to the Y electrode lines.

### BRIEF DESCRIPTION OF THE DRAWINGS

The above objects and advantages of the present invention will become more apparent by describing in detail preferred embodiments thereof with reference to the attached drawings in which:

FIG. 1 shows an internal perspective view illustrating the structure of a general three-electrode surface-discharge plasma display panel;

FIG. 2 shows an electrode line pattern of the plasma display panel shown in FIG. 1;

FIG. 3 is a cross section of an example of a pixel of the plasma display panel shown in FIG. 1;

FIG. 4 is a timing diagram showing the format of a unit display period based on a general method for driving the plasma display panel shown in FIG. 1;

FIGS. 5A through 5K are voltage waveform diagrams of driving signals in a unit display period based on a conventional driving method;

FIGS. 6A through 6K are voltage waveform diagrams of driving signals in a unit display period based on a method of driving a plasma display panel according to an aspect of the present invention;

FIGS. 7A through 7K are voltage waveform diagrams of driving signals in a unit display period based on a method of driving a plasma display panel according to another aspect of the present invention;

FIG. 8 is a block diagram of a driving apparatus according to still another aspect of the present invention;

FIG. 9 is a block diagram of a driving apparatus according to still yet another aspect of the present invention; and

FIG. 10 is a block diagram of a driving apparatus according to still yet another aspect of the present invention.

### DESCRIPTION OF THE PREFERRED EMBODIMENT

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

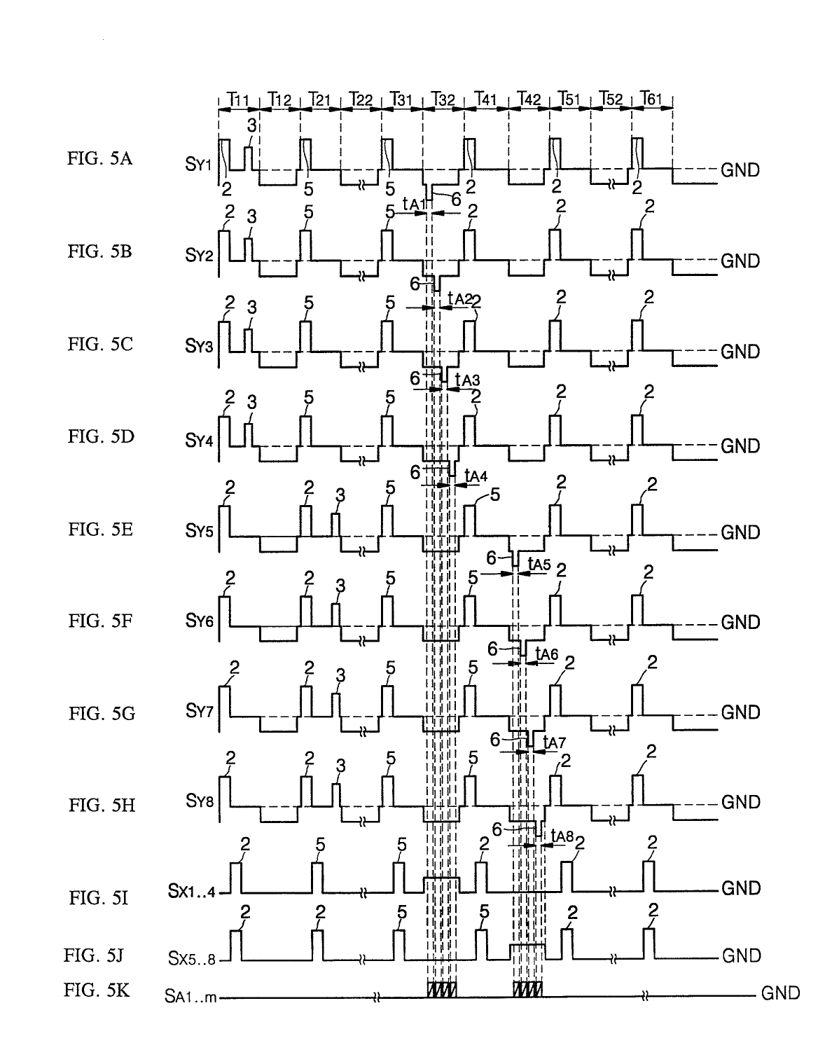

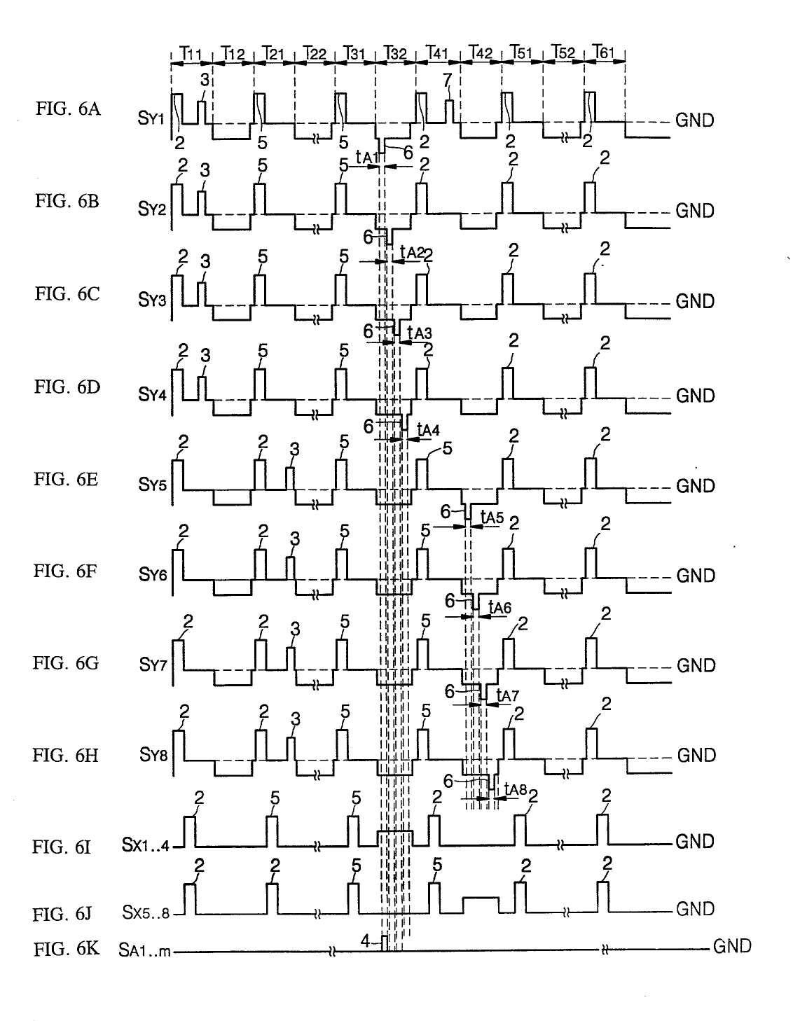

FIGS. 6A through 6K show driving signals in a unit display period based on a driving method according to an aspect of the present invention. Certain aspects of the driving method shown in FIGS. 6A through 6K are the same as those shown in FIGS. 5A through 5K, and only the characteristic parts of the invention will now be described.

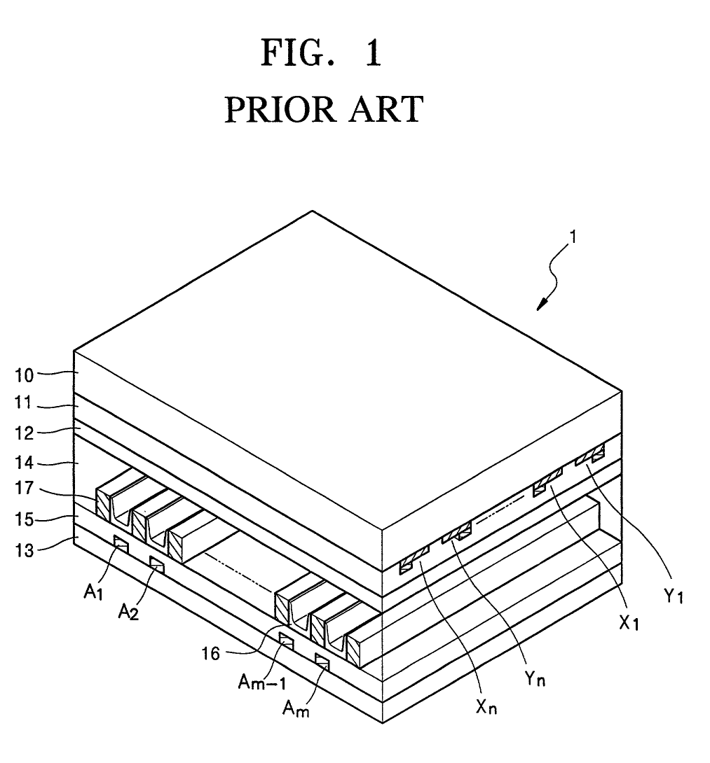

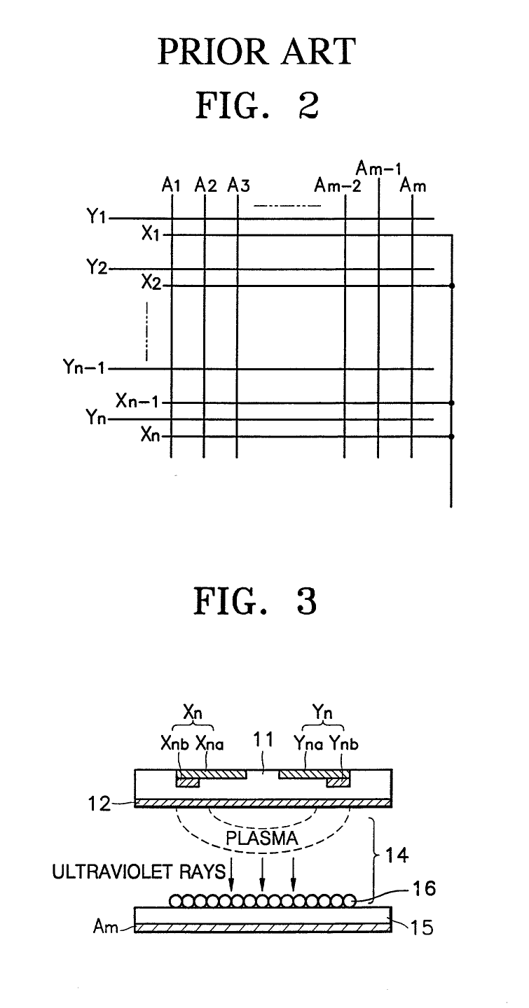

The driving method shown in FIGS. 6A through 6K is adopted in the case where the average brightness of an image displayed on a plasma display panel (1 of FIG. 1) is maintained at a predetermined level or below for a predetermined time. In other words, if the average brightness of an image displayed on the plasma display panel 1 is not maintained at a predetermined level or below for a predetermined time, the conventional driving method shown in FIGS. 5A through 5K is adopted.

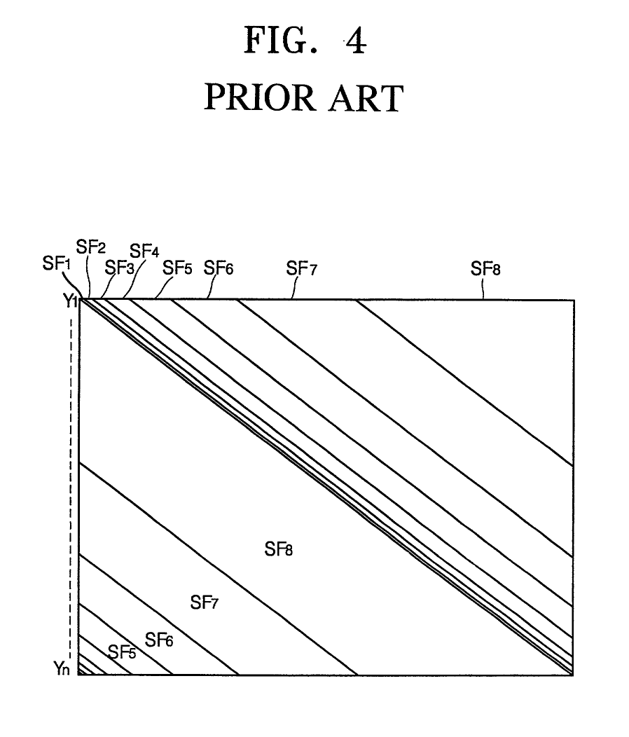

Referring to FIG. 6A, a scan pulse 6 is applied to a selected Y electrode line of the first subfield (SF₁ of FIG. 4) by a driving signal S_{Y1} during the addressing time t_{A1}. Here (see FIG. 6K), a display data pulse 4, rather than normal display data signals S_{A1..m}, is uniformly applied to the respective address electrode lines (A₁, A₂, . . . Aₘ of FIG. 1), wall charges are produced at all display cells corresponding to the selected Y electrode of the first subfield SF₁. Accordingly, display discharge pulses 2 and 5 are applied to the Y and X electrode lines (Y₁, Y₂, . . . Y₄₈₀ and X₁, X₂, . . . Xₙ of FIG. 1) (FIGS. 6A through 6J) during a subsequent period T₄₁, thereby performing display discharges twice at all display cells corresponding to the selected Y electrode line. In this case, the pulses 2 or 5 are simultaneously applied to all Y or X electrodes of the upper or lower panel. However, after the display discharge pulses 2 and 5 are applied to the X electrode lines X₁, X₂, . . . Xₙ (FIGS. 61 and 6J) during the period T₄₁, a new reset pulse 7 is applied to the selected Y electrode line of the first subfield SF₁ (FIG. 6A). Accordingly, no further display discharge is performed.

The driving method shown in FIG. 6 is consistently performed for the entire area of unit display periods, e.g., unit frames based on a sequential driving method or unit fields based on a non-interlaced driving method. Thus, since all display cells perform display discharges twice during the driving time of the first subfield SF₁, the space charges can be prevented from vanishing from display cells at which display discharges do not occur. Since the space charges are not deficient, sufficient wall charges can be produced by performing addressing discharges for radiation of light after a long time. As a result, the discharging stability can be prevented from decreasing even with a prolonged time of displaying the low-brightness image on the plasma display panel.

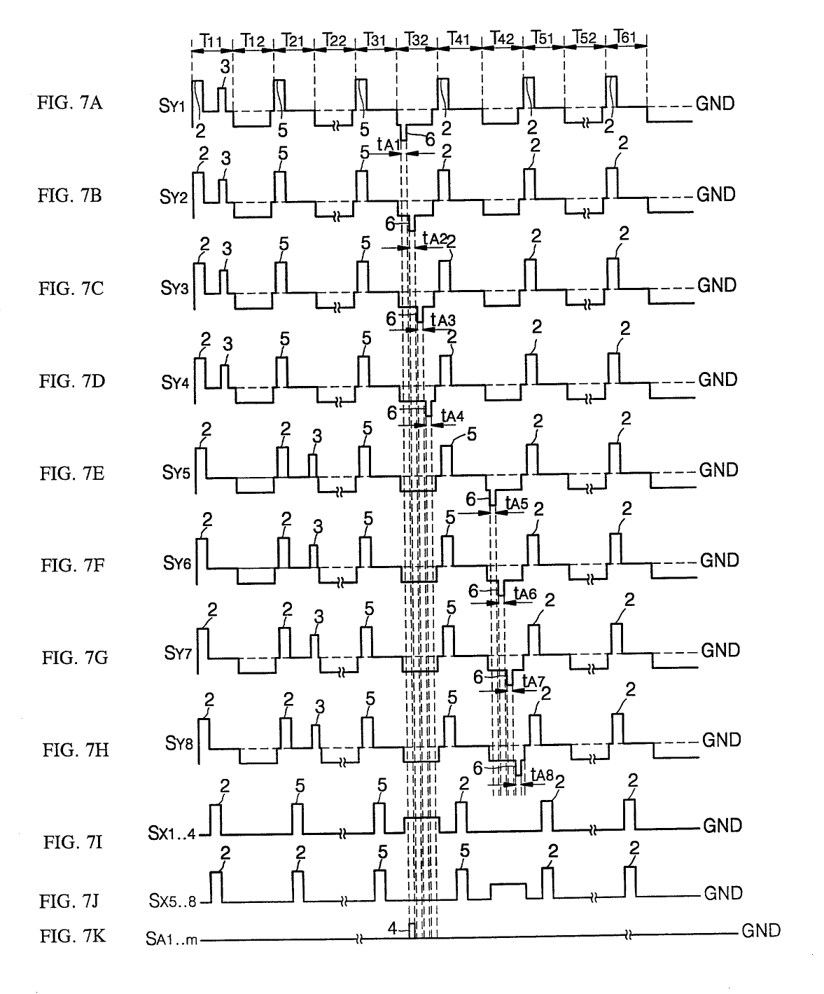

FIGS. 7A through 7K show driving signals of a unit display period according to another aspect of the present invention. In FIGS. 7A through 7K, the same reference numerals denote the same functional elements as those shown in FIGS. 6A through 6K. The driving waveforms shown in FIGS. 7A through 7K are different from those shown in FIGS. 6A through 6K only in that a reset pulse (7 of FIG. 6A) is not generated during the period T₄₁. Thus, within a unit display period, display discharges are performed at all display cells during all time periods allocated to the first subfield SF₁, corresponding to the minimum gray scales, among the subfields.

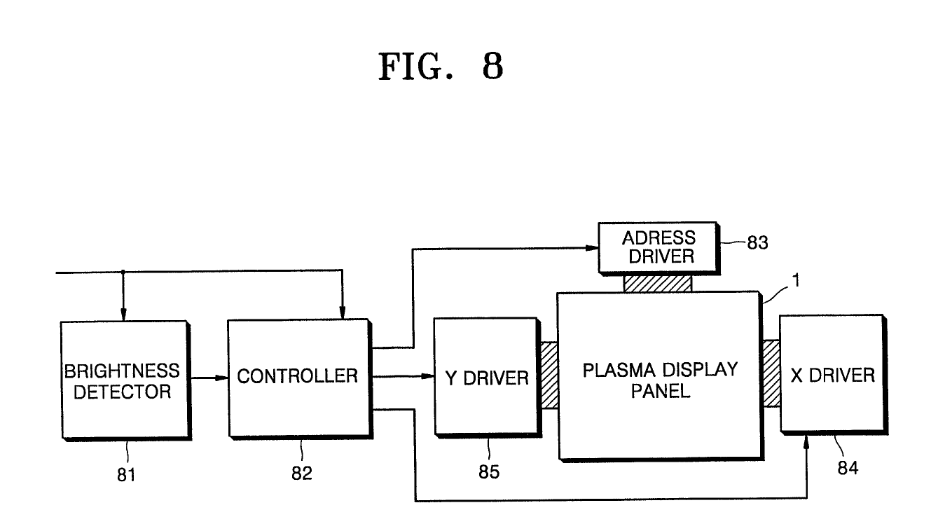

FIG. 8 shows a driving apparatus according to yet another aspect of the present invention. Referring to FIG. 8, the driving apparatus according to the present invention includes a brightness detector 81, a controller 82, an address driver 83, an X driver 84 and a Y driver 85. The brightness detector 81 monitors an image signal externally applied to the controller 82 and generates a brightness control signal indicative of whether or not the average brightness of an image displayed on the plasma display panel 1 is maintained at a predetermined level or below.

The controller 82 generates driving control signals according to the external image signal and the brightness control signal output from the brightness detector 81. In more detail, if the average brightness of an image displayed on the plasma display panel 1 is not maintained at a predetermined level or below, the driving control signals are generated base on the conventional driving method (FIGS. 5A through 5K). However, if the average brightness of an image displayed on the plasma display panel 1 is maintained at a predetermined level or below, the driving control signals are generated based on the driving methods shown in FIGS. 6A through 6K or 7A through 7K.

The address driver 83 processes an address signal among the driving control signals supplied from the controller 82 to generate display data signals (S_{A1..m} of FIGS. 5K, 6K and 7K), and applies the generated display data signals S_{A1..m} to the address electrode lines (A₁, A₂, . . . Aₘ of FIG. 1). The X driver 84 outputs X driving signals according to the driving control signals supplied from the controller 82 and applies the same to the X electrode lines (X, X₂, . . . Xₙ of FIG. 1). The Y driver 85 outputs Y driving signals according to the driving control signals supplied from the controller 82 and applies the same to the Y electrode lines (Y₁, Y₂, . . . Yₙ of FIG. 1).

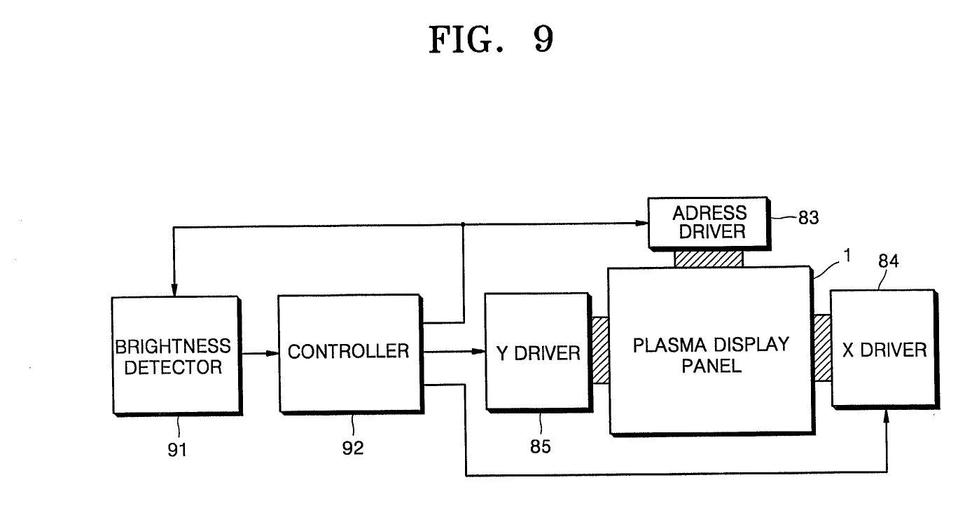

FIG. 9 shows a block diagram of a driving apparatus according to still yet another aspect of the present invention. Referring to FIG. 8, a brightness detector 91 monitors an address signal supplied from a controller 92 to an address driver 83 and generates a brightness control signal indicative of whether or not the average brightness of an image displayed on the plasma display panel 1 is maintained at a predetermined level or below. The functions of the controller 92, the address driver 83, and X and Y drivers 84 and 85 are the same as the controller 82 and the like numbered elements shown in FIG. 8.

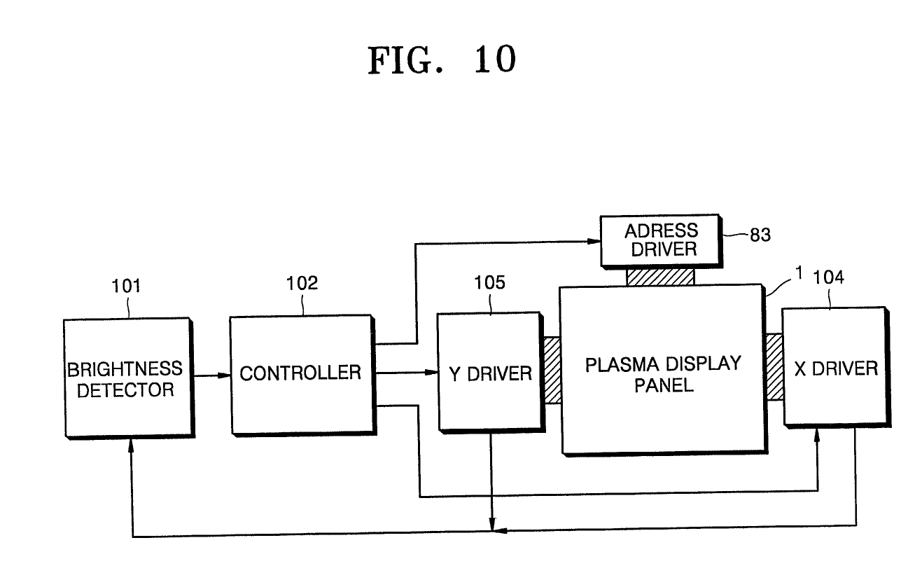

FIG. 10 is a block diagram of a driving apparatus according to a still yet another aspect of the present invention. Referring to FIG. 10, a brightness detector 101 monitors current supplied from an X driver 104 to X electrode lines (X₁, X₂, . . . Xₙ of FIG. 1) and current supplied from a Y driver 105 to Y electrode lines (Y₁, Y₂, . . . Yₙ of FIG. 1) and generates a brightness control signal indicative of whether or not the average brightness of an image displayed on the plasma display panel 1 is maintained at a predetermined level or below. In other words, since the X and Y drivers 104 and 105 apply signals proportional to the output current to the brightness detector 101, respectively, the brightness detector 101 can monitor the average brightness of a displayed image on the basis of power consumption during display discharge periods. The functions of the controller 102 and the address driver 83 are the same as the controller 82 and the like numbered elements shown in FIG. 8.

Thus, any of the driving apparatuses shown in FIGS. 8 through 10 can be used to generate the signals shown in either FIGS. 6A through 6K or 7A through 7K.

As described above, in the driving method and apparatus of the plasma display panel according to the present invention, if the low-brightness image is displayed for a long time, all display cells perform the minimum display discharges within a predetermined time, thereby preventing space charges from vanishing from the display cells at which display discharges do not occur. Since the space charges are not deficient, sufficient wall charges are produced by performing addressing discharges for radiation of light after a long time. As a result, the discharging stability can be prevented from decreasing even with a prolonged time of displaying the low-brightness image on the plasma display panel.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of driving a plasma display panel used to display an image and having front and rear substrates opposed to and facing each other, X and Y electrode lines formed between the front and rear substrates to be parallel to each other, address electrode lines formed to be orthogonal to the X and Y electrode lines, to define corresponding display cells at interconnections, the method comprising:
performing a display discharge at all the display cells at least one time if an average brightness of the image displayed on the plasma display panel is maintained at a predetermined level or below for a predetermined time.

2. The method as claimed in claim 1, wherein a minimum driving period of the plasma display panel includes a display discharge period, a reset period and an address period, the method further comprising:
during the address period, while sequentially applying scan pulses to a selected one of the Y electrode lines, applying corresponding display data signals to respective ones of the address electrode lines to form wall charges at pixels to be displayed;
during the display discharge period, alternately applying display discharge pulses to the X and Y electrode lines to perform display discharges at the display cells where the wall charges have been produced; and
during the reset period, applying a reset pulse for forming space charges to a corresponding Y electrode line while erasing the wall charges remaining from the previous subfield.

3. The method as claimed in claim 1, wherein a plurality of subfields for displaying gray scales occur in a unit display period in an overlapping manner, method further comprising:
applying the address period according to an order of the subfields so that one of the scan pulses is applied to the selected Y electrode line corresponding to at least one of the subfields during the address period and simultaneously the corresponding display data signals are applied to the respective address electrode lines.

4. The method as claimed in claim 3, wherein the performing of the display change comprises entirely performing the display discharge at the subfield, corresponding to the minimum gray scales, among the subfields if the average brightness of the image displayed on the plasma display panel is maintained at the predetermined level or below for the predetermined time.

5. The method as claimed in claim 3, wherein:
during the display discharge period, applying the display discharge pulse to the selected Y electrode line after the application of the scan pulse to the selected Y electrode line, and applying the display discharge pulses to the X electrode lines after the application of the display discharge pulse to the selected Y electrode line;
the method further comprising:
applying a new reset pulse to the selected Y electrode line after the application of the display discharge pulses to the X electrode lines.

6. The method as claimed in claim 1, further comprising:
monitoring an image signal of the image to determine whether the average brightness of the image is maintained at the predetermined level or below for the predetermined time.

7. The method as claimed in claim 1, further comprising:
monitoring an address signal used to generate display data signals to be applied to the address electrode lines, to determine whether the average brightness of the image is maintained at the predetermined level or below for the predetermined time.

8. The method as claimed in claim 1, further comprising:
monitoring current from an X driver to the X electrode lines and current from a Y driver to the Y electrode lines, to determine whether the average brightness of the image is maintained at the predetermined level or below for the predetermined time.

9. An apparatus for driving a plasma display panel used to display an image and having front and rear substrates opposed to and facing each other, X and Y electrode lines formed between the front and rear substrates to be parallel to each other, address electrode lines formed to be orthogonal to the X and Y electrode lines, to define corresponding display cells at interconnections, the apparatus comprising:
a brightness detector which monitors whether an average brightness of the image displayed on the plasma display panel is maintained at a predetermined level or below for a predetermined time and generates a corresponding brightness control signal;
a controller which generates driving control signals according to an externally applied image signal and the brightness control signal output from the brightness detector;
an address driver which processes an address signal among the driving control signals supplied from the controller to generate display data signals and applies the generated display data signals to the address electrode lines;
an X driver which outputs X driving signals according to the driving control signals supplied from the controller and applies the X driving signals to the X electrode lines; and
a Y driver which outputs Y driving signals according to the driving control signals supplied from the controller and applies the Y driving signals to the Y electrode lines;
wherein the controller generates the driving control signals to perform a display discharge at all the display cells at least one time if the average brightness is maintained at the predetermined level or below for the predetermined time.

10. The apparatus as claimed in claim 9, wherein the brightness detector monitors the externally applied image signal to determine whether the average brightness is maintained at the predetermined level or below.

11. The apparatus as claimed in claim 9, wherein the brightness detector monitors address signal supplied from the controller to the address driver to determine whether the average brightness is maintained at the predetermined level or below.

12. The apparatus as claimed in claim 9, wherein the X driver supplies current to the X electrode lines, the Y driver supplies current to the Y electrode lines, and the brightness detector monitors current supplied from the X driver to the X electrode lines and current supplied from the Y driver to the Y electrode lines to determine whether the average brightness is maintained at the predetermined level or below.

13. An apparatus for driving a plasma display panel used to display an image in which a unit frame is divided into a plurality of subfields, wherein the plasma display panel has a plurality of display cells, the apparatus comprising:
a brightness detector which determines whether an average brightness of the image is maintained at or below a predetermined level for a predetermined time; and
a driving circuit which performs display discharges at all of the display cells during all time periods allocated to one of the subfields if the brightness detector determines that the average brightness of the image is maintained at or below the predetermined level for the predetermined time.
